(19) United States
(12) Patent Application Publication
(10) Pub. No.: US 2024/0112253 A1
(43) Pub. Date: Apr. 4, 2024

(54) SYSTEMS AND METHODS FOR DYNAMIC PRODUCT SUMMARY IMAGES

(71) Applicant: Amazon Technologies, Inc., Seattle, WA (US)

(72) Inventors: Syama Prasad Suprasadachandran Pillai, Bangalore (IN); Trisa Sarkar, Bangalore (IN); Pankaj Kothari, Bangalore (IN); Rahul Chaubey, Redmond, WA (US)

(73) Assignee: Amazon Technologies, Inc., Seattle, WA (US)

(21) Appl. No.: 17/936,213

(22) Filed: Sep. 28, 2022

(51) Int. Cl. G06Q 30/06; G06Q 30/02

(52) U.S. Cl. CPC G06Q 30/0643; G06Q 30/0205; G06Q 30/0627

(57) ABSTRACT

Systems, methods, and computer-readable media are disclosed for systems and methods for dynamic product summary images. The dynamic product summary images may be displayed on product pages or in association with individual product search results. The dynamic product summary images may comprise a number of different visual icons that provide a customer quick and easily-digestible information about a product. The dynamic product summary image may also be specific to the user such that different users may be presented with different icons based on details about the product that they are likely to find most important. For example, a dynamic product summary image for a laptop may include an icon indicating a processor type, an icon indicating a graphics card type, an icon indicating an operating system, etc. This provides for a more efficient product browsing process and mitigates or eliminates the need for the customer to search the entire product page for important details about the product.

### BACKGROUND

Customers shopping for products online may often search for such products using a website or smartphone application, for example. The customer may be able to search for different types of products based on search criteria input by the customer. The customer may also be able to view search results including recommended products based on the search criteria. The customer may also be able to select a particular product and view more detailed information about that specific product. Oftentimes, the customer may only be interested in a few specific types of information about the product. However, in order to find this information, the customer may need to review the entire product describe found on the website or application page associated with the product. This may be a time-consuming process and may not be the most efficient way for the customer to search for products.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic illustration of an example use case for display of a dynamic product summary image in accordance with one or more example embodiments of the disclosure.

FIG. 2 depicts an example process flow for a dynamic product summary image using machine learning in accordance with one or more example embodiments of the disclosure.

FIG. 3 depicts an example search results user interface including one or more dynamic product summary images in accordance with one or more example embodiments of the disclosure.

FIG. 4 depicts an example dynamic product summary image in accordance with one or more example embodiments of the disclosure.

FIGS. 5A-5B depict additional example dynamic product summary images in accordance with one or more example embodiments of the disclosure.

FIG. 6 is an example flow diagram in accordance with one or more example embodiments of the disclosure.

FIG. 7 is a schematic illustration of an example system in accordance with one or more example embodiments of the disclosure.

FIG. 8 is a schematic block diagram of an illustrative device in accordance with one or more example embodiments of the disclosure.

### DETAILED DESCRIPTION

### Overview

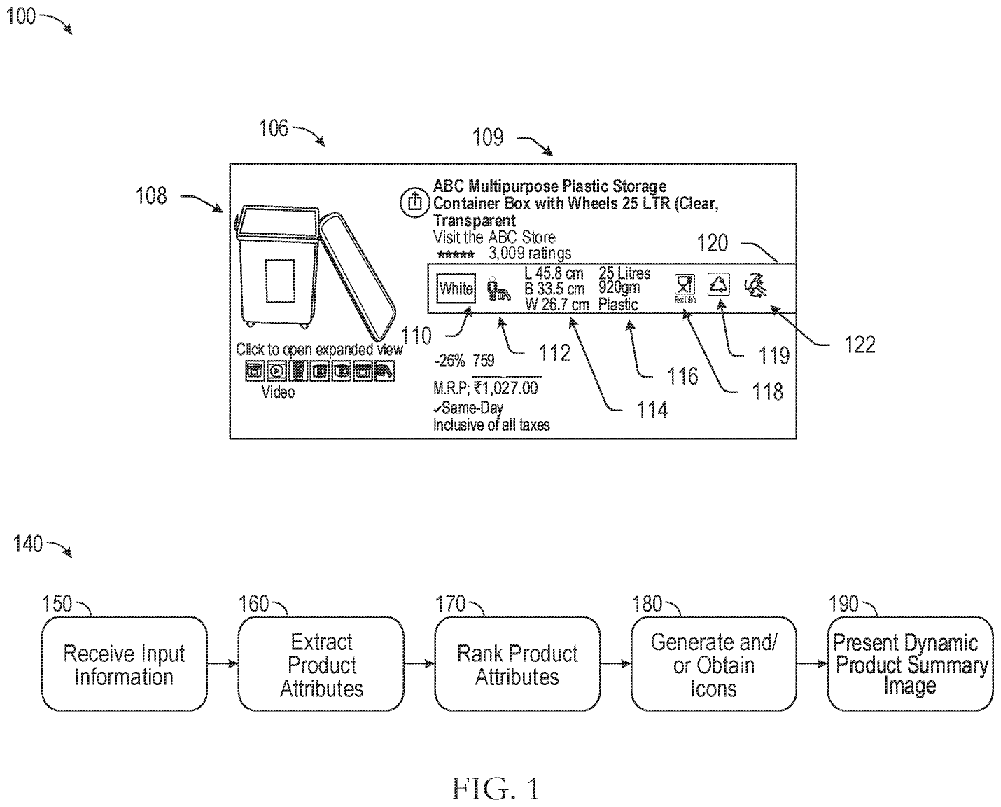

This disclosure relates to, among other things, devices, systems, methods, computer-readable media, techniques, and methodologies for dynamic product summary images. A dynamic product summary image may be an image that is presented to a user within a web page associated with a product (illustrations of example dynamic product summary images are presented in at least FIGS. 1 and 3-5). The dynamic product summary image includes one or more different icons providing concise, easily-accessible information to a user relating to different attributes of the product that are deemed most relevant to the user. As a few non-limiting examples, a user browsing for storage bins may desire to obtain information about a size of the storage bin, a brand of the storage bin, a weight of the storage bin, a color of the storage bin, etc. However, the same or a different user browsing for a gaming laptop may desire to view different information, such as a graphics card included in the laptop, a screen resolution of the laptop, a battery life of the laptop, etc. In some instances, the location of this information may not necessarily be intuitive for a particular user. Even if the location of the information is intuitive, accessing the information may still be a time-consuming and inefficient process for the user.

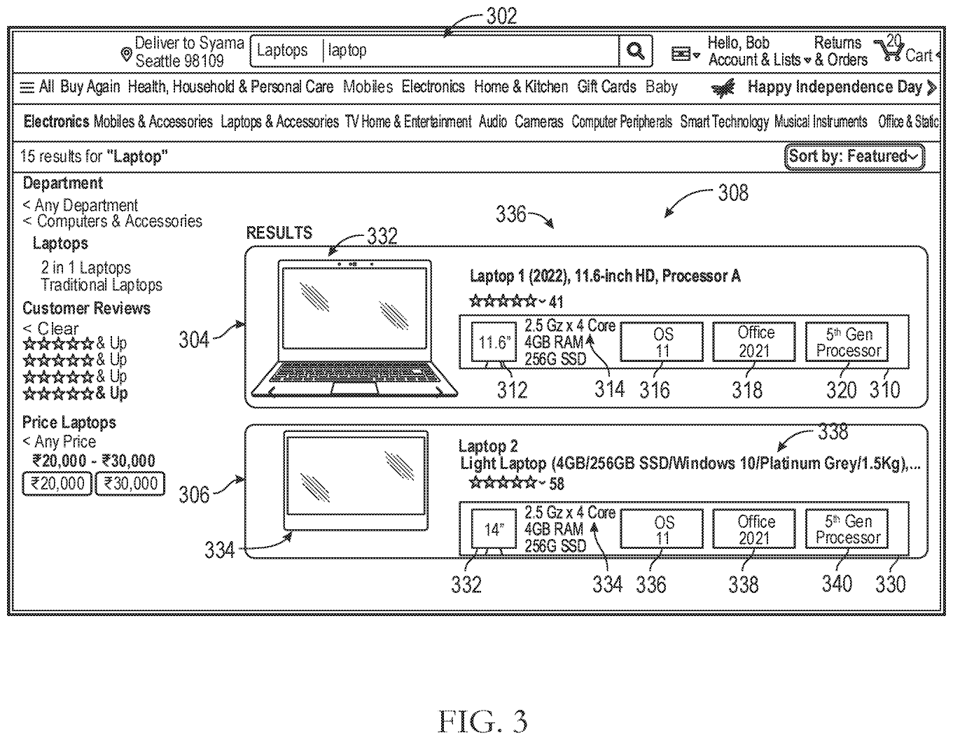

The dynamic product summary image is not necessarily limited to presentation on an individual product page, but may also be presented in any other context in which a user is browsing for a product as well. As one additional non-limiting example, multiple dynamic product summary images may be presented in association with product listings provided on a search results page when a user inputs a search query into a website for a product (an example of this is shown in FIG. 3). These dynamic product summary images may also be presented in any other context involving the presentation of information associated with a product as well. Additionally, while reference is made herein to websites or web pages, one of ordinary skill in the art will understand that these dynamic product summary images may also be displayed in any other context as well (for example, through a smartphone application, a smart television, a desktop application, and/or any other context). Thus, any reference to a “website,” “web page,” “page,” or the like is not necessarily intended to be limiting to such a context and may merely be provided as an example.

Among other reasons, the dynamic product summary image is beneficial in that it provides product attributes that are most important to a user within a single location such that the user is not required to search product information throughout the product web page to ascertain the information. For example, the user may need to scroll down in the web page to a product specifications description to find information about a size of the product and then may need to scroll to another portion of the web page to view information about whether the product is microwave safe. Additionally, it may not necessarily be clear to the user where in the product web page this information exists.

This use of the icons in the dynamic product summary image also provides the benefit of presenting this information to the user in a more easily-digestible form. That is, the icons may be visual indicators that provide the user with quick and easily-identifiable information about the attributes that are important to the user. This contrasts with the more time-consuming approach of reading text-based product descriptions. All of these factors provide for a more time-efficient product browsing experience for a user.

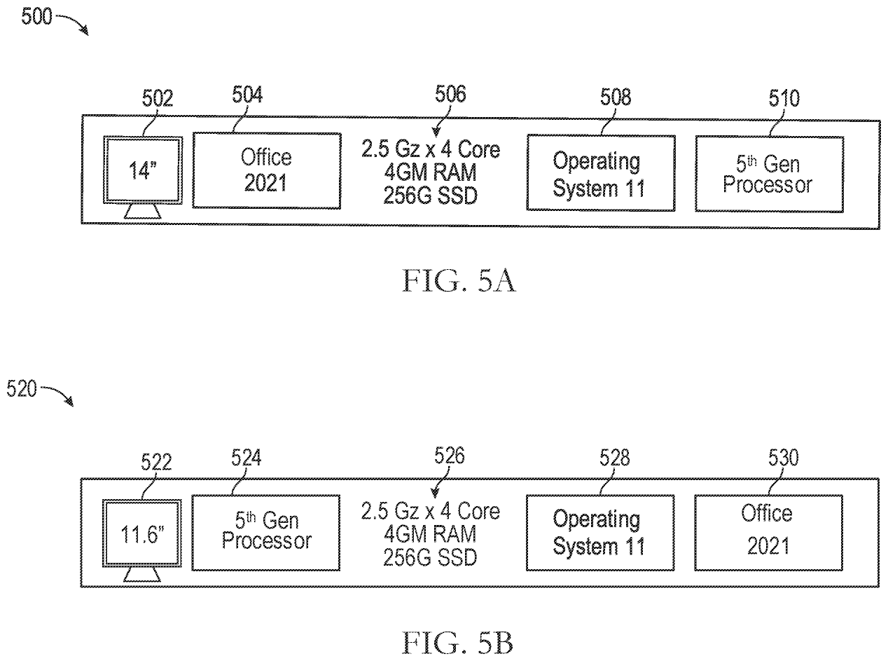

The dynamic product summary image is also beneficial in that the dynamic product summary image is presented in a user-specific manner. As an example, the types of icons comprising a dynamic product summary image may be modified in real-time depending on the specific search query provided by the user. For example, FIGS. 5A-5B (described in greater detail below) illustrate that a slight modification to a search string for a laptop may result in different icons (or a different order and/or other configuration of icons) being included within the dynamic product summary image. This may be the case even within a single product browsing session by the user. For example, the user may first input a search string “laptop with word processing software,” which may result in a dynamic product summary image including a first set of icons (and/or order of icons and/or other configuration of icons) being presented to the user. A user may then, in the same product browsing session, input a second search string “gaming laptop,” which may result in a dynamic product summary image including a second set of icons (and/or a different order of the same icons and/or a different configuration of the same icons). Thus, different icons may be included in different dynamic product summary images even for the same product listing depending on various factors, such as the search string provided by the user.

The icons themselves may also be dynamic, such that a single product attribute may be associated with multiple different icons. For example, certain types of universal symbols for particular product attributes may vary depending on the particular region in which the user resides or a language of the user. Thus, one dynamic product summary image for one user in one region may include different types of icons than another dynamic product summary image for a second user in another region, even if the icons represent the same types of product attributes. The dynamic product summary image may also be dynamic in any other number of different ways described herein or otherwise.

While reference is made herein to a dynamic product summary image, the presentation of the information to the user may not necessarily be limited to an image format. For example, auditory information may be provided to a user, a video may be provided to a user, and/or any other type of format.

Referring to FIG. 1, an example use case 100 illustrating an example dynamic product summary image is depicted in accordance with one or more example embodiments of the disclosure. The use case 100 illustrates a portion of a web page 106 associated with a specific product. The web page 106 may provide information about the product. For example, the web page 106 shows a product image 108 (in this case, the product is a trash bin). The web page 106 also shows a product name 109. The web page 106 may also display any other types of information, such as more detailed product descriptions, images and/or videos, user reviews of the product, a questions and answers section, selectable options to purchase the product, and/or any other types of information and/or features. This illustration of the web page 106 may not necessarily be comprehensive and only serves to illustrate the dynamic product summary image 120 within an example product web page. For example, the web page 106 may also allow the user to select an option to purchase the product (for example, the user may select a button with a mouse cursor to navigate to a purchase page for the product). Further examples of dynamic product summary images are also illustrated in at least FIGS. 3-5. Additionally, as aforementioned, although the use case illustrates a dynamic product summary image presented on a web page, this is not intended to be limiting, and the dynamic product summary image may also be presented in any other context as well.

To produce and present the dynamic product summary image 120, an example process flow 140 is presented and may be performed, for example, by one or more remote servers. The remote server and/or computer system may include at least one memory that stores computer-executable instructions and at least one processor configured to access the at least one memory and execute the computer-executable instructions to perform various actions or operations, such as one or more of the operations in the process flow 140 of FIG. 1. The process flow 140 is merely intended to provide a high-level example operations performed in association with the presentation of the dynamic product summary image 120 (including any processes involved in receiving any input data, determining product attributes, and/or any other processes) and is not intended to be limiting in any way.

At a first block 150, input data may be received. This input data may include any types of data that may be used to determine product attributes that are most relevant to a user. One type of such input data may include the search query itself (for example, the search string provided by the user, an audible command provided by the user, and/or any other type of search query that a user may provide when searching for a product).

Another type of such input data may include prior search queries provided by the user. In some instances, these prior search queries may only include search queries that are associated with similar types of products to a product for which the user is currently searching. For example, if a user is currently searching for a laptop, prior search queries provided by the user for laptops may be considered. Search queries for similar types of products may also be considered as well. For example, continuing the example of the search query for the laptop, prior search queries for desktops, computers, tablets, etc. may also be considered. In further cases, these prior search queries may also include search queries for any other types of products as well (even products that may be unrelated to the product associated with the current search query). These prior search queries may provide historical context for attributes that the user previously indicated were more important.

Another type of input data may include any review comments provided by the user with respect to similar types of products to a product the user is currently searching for and/or any other review comments relating to other comments in general. For example, the web site may provide the capability for a user to post a review of the product in which the user expresses their thoughts about various aspects of the product, such as the quality of the product, the usability of the product, etc. For example, a user may have previously posted a review comment to a product page for a laptop indicating that the laptop screen size is too small. Based on this comment, it may be determined that the screen size attribute is an impotent attribute for the user. The review comments may also extend beyond related products as well. For example, a review comment posted to a product page for a bowl indicating that the bowl is of a poor quality may be a relevant data point for the laptop search query because the review comment may indicate that the user generally values quality products. These types of comments may also provide additional insight into the types of attributes for a specific product (or products in general) that are important to the user.

Another type of input data may include may product description that is provided on the product page. For example, information included in the product name and any product descriptions included within the product page may be extracted. In some cases, these product descriptions may be used to determine product attributes, however, the product descriptions may also be used for other purposes as well. As described below, the product descriptions may be used to determine specific icons to include in a dynamic product summary image for each of the attributes that are determined to be included in the dynamic product summary image. For example, a product description relating to the dimensions of a product may be used to generate and/or obtain an icon relating to a size attribute of the product.

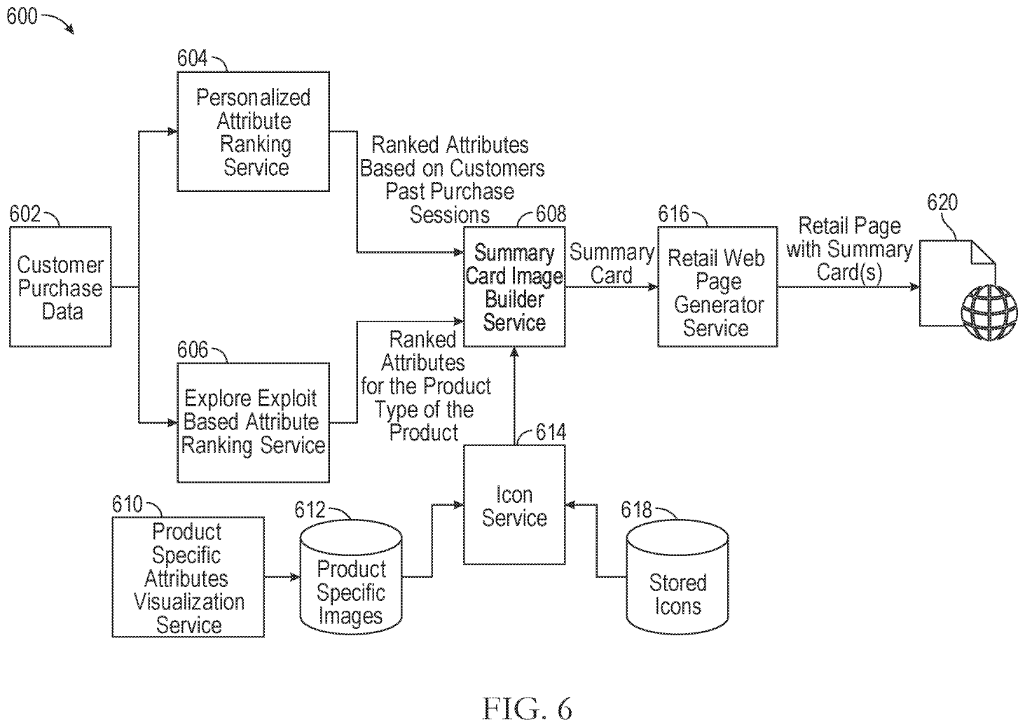

At a second block 160, product attributes may be determined. In some instances, all of the potential attributes associated with a given type of product may be determined. However, in other cases, a subset of all of the attributes associated with the type of product may instead be determined. This subset may include attributes that are determined to be most relevant to the user based on the input data and/or any other data. An example of an algorithm that may be used to determine these relevant attributes is described with respect to FIG. 6. However, this is merely one approach to determining the relevant attributes and any other suitable method may also be used as well. For example, a look-up table may be referenced, which may include product types and attributes associated with those product types.

At a third block 170, the product attributes determined in block 170 may be provided individual ranking scores. Providing such ranking scores may allow for the dynamic product summary image 120 to be limited to only including a threshold number of icons representing a select number of attributes that are deemed most important to the user for the specific type of product (or in general). For example, if the product is a trash bin (shown in the figure through the product image 108) and the trash bin is associated with 50 total possible attributes, only the top 5-10 (or any other number) attributes may be presented as icons through the dynamic product summary image 120. Otherwise, a product may be associated with a large number of attributes and it may not be practical or efficient to present icons associated with all of these different attributes. However, in some cases, icons associated with all of the attributes may be presented on the dynamic product summary image 120 as well.

The figure shows a total of seven icons being presented in the dynamic product summary image 120. A first icon 110 shows that color of the trash bin. A second icon 112 shows a relative size of the trash bin. A third icon 114 shows dimensions of the trash bin. A fourth icon 116 shows a volume of the trash bin and a material of the trash bin. A fourth icon 118 indicates that the trash bin is microwave safe. A fifth icon 119 indicates that the trash bin is recyclable. A sixth icon 122 indicates that the trash bin is breakable.

In one or more embodiments, the ranking scores provided for each attribute may not only indicate which attributes may be presented in the dynamic product summary image 120, but may also indicate the manner in which the icons are presented in the dynamic product summary image 120. For purposes of this example, the color attribute may be provided a ranking score of 1, the size attribute may be provided a ranking score of 2, the dimensions attribute may be provided a ranking score of 3, the volume and material information attribute may be provided a ranking score of 4, the microwave safe attribute may be provided a ranking score of 5, the recyclability attribute may be provided a ranking score of 6, and the breakability attribute may be provided a ranking score of 7. These ranking scores may indicate that the color of the trash bin is most important and the breakability is the least important.

Based on these relative ranking scores, the icon indicating the color of the trash bin may be presented such that the user views this icon first. For example, the figure shows the first icon 110 as being presented at the left hand side of the dynamic product summary image 120. In regions in which people read from left to right, this may be the icon that the user would view first. However, the manner in which the icons are configured based on ranking scores is not necessarily just limited to order. For example, the first icon 110 could also be presented as a larger icon than the other icons. Rather than being presented on the left or right hand side of the dynamic product summary image 120, the first icon may instead be presented in the middle of the other icons. The first icon 110 may also be emphasized over the other icons in any other suitable manner.

Although the above example indicates that the ranking scores are provided in the form of integer values, this is not intended to be limiting. The ranking scores may similarly be provided in any other form as well. Additionally, while the example explains that a lower value integer is indicative of a more important attribute, this is also not necessarily intended to be limiting. As one additional non-limiting example, a higher value integer may instead be indicative of a more important attribute. Additional information about the algorithm that may be used to determine the ranking scores is described with respect to FIG. 6.

At a fourth block 180, one or more icons may be generated and/or obtained for the attributes identified in block 170. In some instances, some or all of the attributes may already include pre-generated icons. For example, some of the attributes may be associated with universally-known icons, such as the symbol indicating the recyclability of a product. The pre-existing icons may also extend beyond these universally-known icons. For example, the third icon 114 shown in the figure may not necessarily be a universal icon, but may be a pre-generated dimensions icon for any type of product, and the specific dimensions for the product may be populated into the icon. Any of the other icons may also be pre-generated in any manner (for example, manually generated by a user or automatically generated).

The icons for the various attributes may be determined based on the product information and/or any other sources of information. For example, while block 160 involves determining the types of attributes that are provided ranking scores, the product-specific information associated with these attributes may still need to be determined. For example, an attribute for a trash bin may include a size attribute. However, the size information specific to the trash bin may need to be determined to associate with this size attribute.

Additionally, in some instances, pre-generated dynamic product summary images may also be stored. These pre-generated dynamic product summary images may include, for example, dynamic product summary images including a common configuration of different icons that are determined to be presented to a large number of users. As another example, dynamic product summary images that were previously presented to a user may be stored such that these dynamic product summary images may not need to be generated again if the user were to view the web page multiple times (or view the product at another location. This may reduce the amount of processing that is required to generate and present the dynamic product summary images in some instances.

In one or more embodiments, any of the icons may be stored in a database (for example, database 730 and/or any other database described herein or otherwise. When attributes for a product and user are determined and the icons that are associated with those attributes are also determined, the associated icons may be obtained from the database to generate the dynamic product summary image 120.

At a fifth block 190, a dynamic product summary image may be presented. That is, the icons that are generated and/or obtained in the fourth block 180 may be compiled into a single image that may form the dynamic product summary image 120. One of ordinary skill in the art will understand that this may not necessarily be limited to just a single image. For example, each icon may be presented as individual images on the web page. Additionally, as aforementioned, the dynamic product summary image may not necessarily even be limited to an image presentation. For example, the information may be presented as an auditory output, a video, etc.

The configuration of the dynamic product summary image 120 itself may not necessarily be limited to the horizontal orientation shown in the figure. For example, the dynamic product summary image 120 may be presented in a vertical orientation, with the one or more icons being stacked vertically. As another example, the dynamic product summary image 120 may be presented in a “square” orientation comprising multiple columns and rows of icons rather than the dynamic product summary image 120 including only a single row or a single column of icons. The dynamic product summary image 120 may also be presented in any other form as well.

Additionally, the size of a dynamic product summary image 120 may not necessarily be fixed, and may be modified based on a number of different factors. For example, a dynamic product summary image 120 may be re-sized depending on the type of device on which the user is browsing for products. As another example, a font size, icon size, and/or overall size of a dynamic product summary image 120 may depend on user-specific conditions, such as if a user has trouble reading smaller fonts. The size of a dynamic product summary image 120 may also be modified for presentation to a user based on any other number of factors as well.

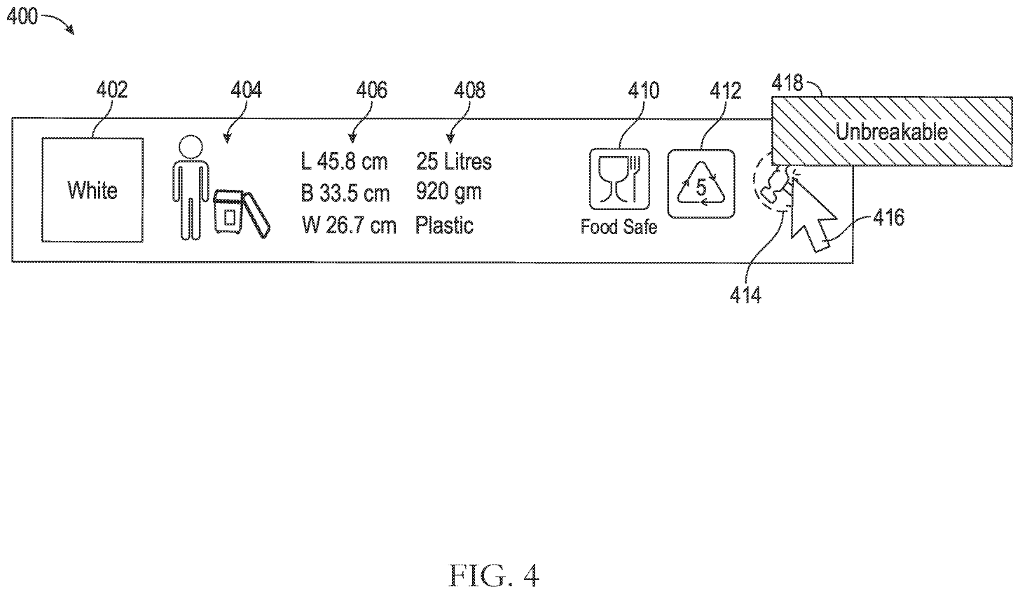

Furthermore, while a dynamic product summary image may be displayed on an individual web page associated with a single product, one or more dynamic product summary images may also be displayed for some or all of the products that are displayed in a search results page (for example, as illustrated in FIG. 4) as well. This may allow a user to quickly view the most important information about the products in the search results. This may reduce or eliminate scenarios where a user is required to select a particular product from the search results listing so that the user can navigate to the individual product's web page to ascertain the necessary information about the product. Thus, the use of the dynamic product summary images on the search results pages provide for more efficient product browsing by the user.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

### Illustrative Process and Use Cases

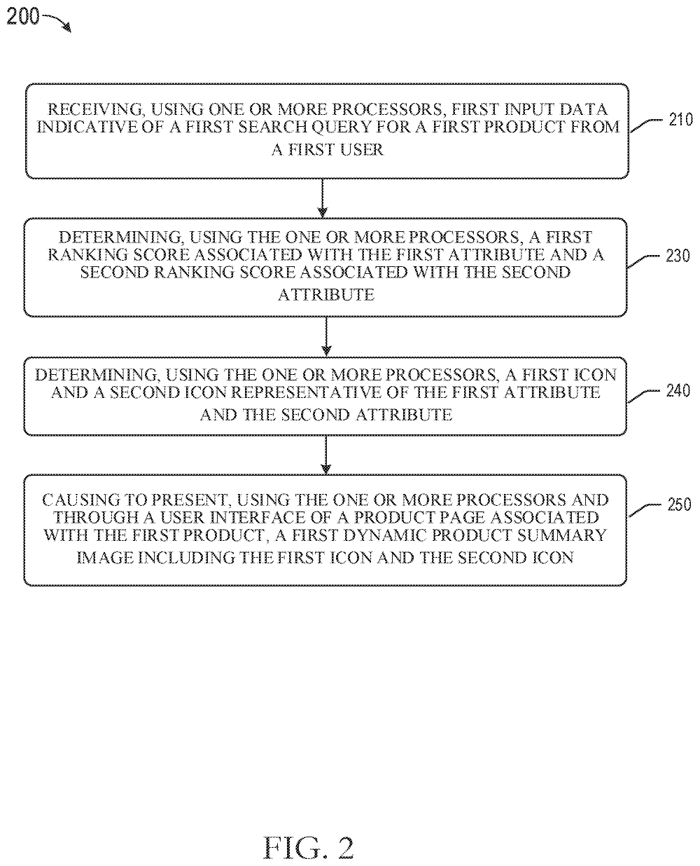

FIG. 2 depicts an example process flow 200 for generation and presentation of dynamic product summary images in accordance with one or more example embodiments of the disclosure. The process flow 200 may provide a more detailed illustration of the processes associated with the process flow 140 of FIG. 1. While example embodiments of the disclosure may be described in the context of movies or other video content, it should be appreciated that the disclosure is more broadly applicable to any type of digital content. Some or all of the blocks of the process flows in this disclosure may be performed in a distributed manner across any number of devices. The operations of the process flow 200 may be optional and may be performed in a different order.

At block 210 of the process flow 200, computer-executable instructions stored on a memory of a device, such as computing device 800 and/or any other device, may be executed to receive first input data indicative of a first search query for a first product from a first user. For example, as illustrated in at least FIG. 3, a user may enter a search string into a search bar of a web site and the web site may then display a listing of products that match the search string in a search results page. In this example, the search query may comprise the string that was input by the user into the web site. The illustration shown in FIG. 3 shows a “laptop” search string input by a user, however, a user may also input any other type of search string as well. For example, the user may enter a search string relating to a different type of product and/or may provide a more detailed search string including more granular search criteria. For example, a user who is searching for a gaming laptop to purchase may input a “gaming laptop” search string.

Additionally, the first input data may also include any other types of inputs described herein. For example, the input data may also include prior searches performed by the user. The input data may also include review comments provided by the user associated with the product or other products. The input data may also include questions and answers provided by the user. The input data may also include geographical information and/or language information associated with the user.

At block 230 of the processor flow 200, computer-executable instructions stored on a memory of a device, such as computing device 800 and/or any other device, may be executed to determine a first ranking score associated with the first attribute and a second ranking score associated with the second attribute.

At block 240 of the processor flow 200, computer-executable instructions stored on a memory of a device, such as computing device 800 and/or any other device, may be executed to determine a first icon and a second icon representative of the first attribute and the second attribute.

At block 250 of the processor flow 200, computer-executable instructions stored on a memory of a device, such as computing device 800 and/or any other device, may be executed to cause to present, through a user interface of a product page associated with the first product, a first dynamic product summary image including the first icon and the second icon. In one or more embodiments, a product page may be a portion of an online retail system that is specific to the first product (for example, provides information about the first product, allows a user to purchase the first product, etc.). The product page may be a web page, a page accessible through an application associated with a smart phone, and/or any other type of product page. For example, FIG. 1 may present a portion of a product page for a trash bin and FIG. 3 shows a search results page in which a user may select a specific product to be directed to the product page for that product.

One or more operations of the methods, process flows, or use cases of FIGS. 1-2 may have been described above as being performed by a user device, or more specifically, by one or more program module(s), applications, or the like executing on a device. It should be appreciated, however, that any of the operations of the methods, process flows, or use cases of FIGS. 1-2 may be performed, at least in part, in a distributed manner by one or more other devices, or more specifically, by one or more program module(s), applications, or the like executing on such devices. In addition, it should be appreciated that the processing performed in response to the execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-2 may be described in the context of the illustrative devices, it should be appreciated that such operations may be implemented in connection with numerous other device configurations.

FIG. 3 depicts an example search results user interface 300 including one or more dynamic product summary images in accordance with one or more example embodiments of the disclosure.

The figure illustrates that the dynamic product summary images may be presented to a user at various points in the product browsing process, and are not limited to presentation on a specific product page (for example, as shown in FIG. 1). For example, the figure shows that one or more dynamic product summary images may also be displayed next to products listings provided on a search results page 308. The search results page 308 may be presented to a user following the receipt of search criteria that is input by the user into a search bar 302 of the website. Presenting the dynamic product summary images in the search results may provide further benefits to a user in that the user may not necessarily need to select an individual product and open the individual product's page to view the dynamic product summary image associated with the product. Instead, the user may be able to more efficiently scroll through a listing of products that are presented based on the search criteria while being presented with the information that is deemed most important to the user and/or the product through the dynamic product summary images shown with the search results page 308.

The positioning of the dynamic product summary images within the search results page 308 as shown in the figure is not intended to be limiting. That is, the dynamic product summary images may also be presented at any other position relative to the product listings. Further, dynamic product summary images may also not necessarily need to be presented in the search results page 308 by default. For example, the search results page 308 may present the product images and descriptive text, and the user may be able to view the dynamic product summary images by hovering a mouse cursor over a product listing within a search result. The dynamic product summary images may also be presented in any other suitable manner within the search results page 308.

The search criteria may be a search string in a text format and/or any other type of search criteria. For example, the figure shows an example “laptop” search string that was input by a user into the search bar 302. Specifically, the figure shows search results that were generated based on the “laptop” search string input by the user into the search bar 302. The search results include at least a first product listing 304 and a second product listing 306 (for example, a first laptop and a second laptop). The first product listing 304 includes a first product image 332, a first product description 336 (which may be in a text format), and a first dynamic product summary image 310. The second product listing 306 includes a first product image 334, a first product description 338 (which may be in a text format), and a second dynamic product summary image 330.

The first dynamic product summary image 310 and the second dynamic product summary image 330 may each include one or more icons. For example, the first dynamic product summary image 310 may include a first icon 312, second icon 314, third icon 316, fourth icon 318, and fifth icon 320. The first icon 312 may present information about a screen size of the laptop. The second icon 314 may present information about hardware specifications of the laptop, the third icon 316 may present information about an operating system installed on the laptop. The fourth icon 318 may present information about software installed on the laptop. The fifth icon may include information about a generation of processor included in the laptop.

Similarly, the second dynamic product summary image 330 may include a sixth icon 332, a seventh icon 334, an eighth icon 336, a ninth icon 338, and a tenth icon 340. However, either of the first dynamic product summary image 310 and the second dynamic product summary image 330 may also include any other number of icons. In one or more embodiments, the sixth icon 332, seventh icon 334, eighth icon 336, ninth icon 338, and tenth icon 340 may present the same (or similar) information as the first icon 312, second icon 314, third icon 316, fourth icon 318, and fifth icon 320. In this manner, the user may be able to more effectively compare products presented in the search results 308 based on similar types of information included in the dynamic product summary images. However, in some cases, some or all of the icons associated with the different products listed in the search results may differ as well. Additionally, while the figure shows dynamic product summary images including five different icons, any other number of icons may also be used. For example, in some cases, it may be desirable to use dynamic product summary images with less icons to preserve space within the search results page 308 for presentation of a larger number of product listings at the same time.

In one or more embodiments, the content of the dynamic product summary images may also be modified in real-time for a single user performing a search for a product. For example, the user may enter a first search string including laptop and an operating system. Based on this, the dynamic product summary images that are shown with the search results page 308 may include an icon presenting information about the operation systems associated with each of the laptops. However, if the user then inputs a second search string including laptop and a type of graphics card, the dynamic product summary images that are shown within the search results page 308 may instead include an icon presenting information about the graphics cards included in each of the laptops.

In some cases, both icons may be displayed, but the order and/or other properties of the icons may be modified such that the icon associated with the graphics card information is emphasized more than the icon associated with the type of operating system. For example, the icon associated with the graphics card could be located closer to the left hand side of the dynamic product summary image (or the right hand side depending on the user's region and/or language). As another example, the icon associated with the graphics card may be larger than the icon associated with the operating system. As another example, the icon associated with the graphics card may be positioned in the middle of the dynamic product summary image. The icon associated with the graphics card may also be emphasized over the icon associated with the operating system in any other manner described herein or otherwise.

Additionally, in one or more embodiments, the appearance of the dynamic product summary image may also be configured differently in the search results listing than it would be configured on a specific product page. For example, the overall size of a dynamic product summary image presented on the search results listing may be smaller in size than a similar dynamic product summary image presented on a specific page associated with an individual product. In such cases, the size of the dynamic product summary images may be reduced by reducing the overall size of the image (for example, reducing the size of all of the icons). The size may also be reduced by including a smaller number of icons in the dynamic product summary images shown in association with the search results as compared to the dynamic product summary images shown on the individual product pages. The dynamic product summary images may be configured in this manner to allow mitigate the amount of space in the search results that each individual product encompasses.

The dynamic product summary images may also be configured differently between the search results and the individual product pages in any other manner. For example, the shapes and/or sizes of the dynamic product summary images may differ. However, the dynamic product summary images in the search results and individual product pages may also be configured the same as well.

FIG. 4 depicts another example dynamic product summary image 400 in accordance with one or more example embodiments of the disclosure.

The dynamic product summary image 400 may be an example dynamic product summary image for a trash bin (for example, the dynamic product summary image 400 may be the same as, or similar to, the dynamic product summary image 120). The dynamic product summary image 400 includes seven different icons (a first icon 402, a second icon 404, a third icon 406, a fourth icon 408, a fifth icon 410, a sixth icon 412, and a seventh icon 414).

The figure illustrates that additional information about any of the icons included in the dynamic product summary image 400 may be presented to the user. For example, the figure shows a cursor 416 of a user hovering over the seventh icon 414. Based on the action of the cursor 416 hovering over the seventh icon 414, additional information about the seventh icon 414 is presented in a pop-up window 418. For example, the pop-up window 418 provides additional information that the seventh icon 414 indicates that the product is unbreakable. When the cursor 414 is moved away from the seventh icon 414, the pop-up window 418 may cease to be presented. Although the figure only shows the pop-up window 418 associated with the seventh icon 414, similar pop-up windows may also be presented based on the cursor 416 hovering over any of the other icons.

The use of the pop-up windows may allow for the dynamic product summary image 400 to remain concise and compact within the website, while also allowing users to obtain additional information if necessary. The pop-up windows also provide the additional benefit of providing context to certain icons that may not be universally known. Some icons may include text, which may be easier for a user to comprehend. For example, the first icon 402 may provide information about a color of the product. Some icons may not necessarily include text, but may be in the form of universally known images (such as the “recyclable” icon shown in the fifth icon 410). However, some icons may not be as common and thus some users may not necessarily understand what the icons is intending to represent (for example, a user may not understand that the seventh icon 414 represents that the product is unbreakable). In such cases, the pop-up windows may allow the user to view additional information about such an icon to better understand what the icon represents.

In one or more embodiments, the additional information associated with the icons may also be provided to the user in any other form. As one additional non-limiting example, rather than a pop-up window being presented, an audio recording may play for the user that provides an explanation of the icons. Additionally, this information may also be presented to the user based on any other triggering conditions other than a cursor hovering over the icon as well.

FIGS. 5A-5B depict additional example dynamic product summary images in accordance with one or more example embodiments of the disclosure. Particularly, FIGS. 5A-5B illustrate the dynamic nature of the manner in which icons are presented in the dynamic product summary images based on factors such as specific search strings input by users, even if the products that the users are searching for are the same types of products.

Beginning with FIG. 5A, a first dynamic product summary image 500 is shown. The first dynamic product summary image 500 is an example dynamic product summary image for a laptop that is presented to a user through search results based on a search string, such as “laptop with word processing software” (or any similar type of search string). The first dynamic product summary image 500 includes a first icon 502, a second icon 504, a third icon 506, a fourth icon 508, and a fifth icon 510. The first icon 502 provides information about a screen size of the laptop. The second icon 504 provides information about software installed on the laptop. The third icon 506 provides hardware specifications for the laptop. The fourth icon 508 provides information about an operating system installed on the laptop. The fifth icon 510 provides information about a generation of processor included in the laptop.

Turning to FIG. 5B, a second dynamic product summary image 520 is shown. The second dynamic product summary image 520 is also an example dynamic product summary image for a laptop, but is a dynamic product summary image based on a different search string, such as “laptop with fifth generation processor” (or any similar type of search string). The second dynamic product summary image 520 includes a sixth icon 522, a seventh icon 524, an eighth icon 526, a ninth icon 526, and a tenth icon 530. The sixth icon 522 provides information about a screen size of the laptop. The seventh icon 524 provides information about a generation of processor included in the laptop. The eighth icon 526 provides hardware specifications for the laptop. The ninth icon 526 provides information about an operating system installed on the laptop. The tenth icon 530 provides information about software installed on the laptop.

The first dynamic product summary image 500 and second dynamic product summary image 520 area similar in that they include the same types of icons. However, the order of the icons is not necessarily the same. For example, if it is assumed that a user would read the icons in order from the left hand side of the dynamic product summary image to the right, then, in the first dynamic product summary image 500, the icon providing information about software installed on the laptop (second icon 504) is presented before the icon providing information about the generation of processor (the fifth icon 510). However, in the first dynamic product summary image 520, the icon providing information about software installed on the laptop (tenth icon 530) is presented after the icon providing information about the generation of processor (seventh icon 524).

These figures illustrate one aspect of the dynamic nature of the dynamic product summary images. That is, information that is determined to be more relevant to the user may be presented in a manner such that the user would be likely to view that information before information that is determined to be less relevant. In the case of the first dynamic product summary image 500, it may be determined that the type of software installed on the laptop is important to the user based on the specific search string provided by the user. Thus, the icon including information about the type of software on the laptop is presented before other types of information. In contrast, with the second dynamic product summary image 520, it may be determined that the type of processor included in the laptop is more important to the user based on the different search string provided by the user. Thus, the information about the type of processor is presented before the information about the software installed on the laptop in the second dynamic product summary image 520. Thus, different users may be presented with different configuration of dynamic product summary images, even if the products the users area searching for are the same types of products. Furthermore, even if the same types of icons are presented to the user, the manner in which the icons area presented may differ (as is exemplified through the different order of the icons in the two dynamic product summary images shown in FIGS. 5A-5B).

In one or more embodiments, the dynamic nature of the dynamic product summary images may extend beyond mere ordering of the icons. For example, the size of each individual icon may be dynamic such that icons representing information that is determined to be more important to a user may be larger than icons representing information that is deemed less important to the user. As another example, some of the icons may be emphasized relative to other icons (for example, one or more of the icons may be highlighted, one or more of the icons may include a symbol indicative of a relative important of the icon, and/or any other manner in which any of the icons may be emphasized relative to one another.

The types of icons that are used to represent similar types of information may also vary depending on a number of different factors. For example, a “recyclable” symbol may be one type of symbol in one country and another type of symbol in another country. Thus, the region in which the user resides may also impact the icons that are presented to the user. As further examples, an icon for one region may display a dollar currency symbol, whereas an icon for another region may display a pounds currency symbol. As yet another example, a dimensions icon for one region may display units based on the metric system and a dimensions icon for another region may display units based on the imperial system.

FIG. 6 is an example flow diagram 600 in accordance with one or more example embodiments of the disclosure. The flow diagram 600 may illustrate example operations that may be performed in association with the generation and presentation of the dynamic product summary images as described herein (and/or any other operations). Any of these operations (and/or any of the “services” effectuating the operations) may be performed by any system or device describe herein (for example, computing device 800, device(s) 702, server(s) 720, etc.). Additionally, in some cases, a “service” may refer to an algorithm that is used by a device, system, etc. to perform any operations described with respect to FIG. 6 (or make likewise simply refer to the device or system including the algorithm).

The flow diagram begins with operation 602, which involves receiving input data. In one or more embodiments, the input data may include any search criteria provided by the user for a current product search. The input data may also include search criteria and other data associated with previous product searches performed by the user. For example, the searches may include any text strings that a user may input into a search bar while searching for products (an example is shown in at least FIG. 3). However, the searches may also include any other type of input used to perform a search for a product. The input data may also include questions and/or comments provided by the user with respect to the type of product associated with the product search and/or any other types of similar or unrelated types of products. The input data may also include any other types of relevant data, such as a geographical region of the user, a primary language of the user, and/or any other types of data described herein or otherwise. Additionally, any combination of these example types of input data may also be used.

Operation 604 involves providing the input data received in operation 602 to a personalized attribute ranking service. The personalized attribute ranking service may rank any attributes extracted based on the input data. Particularly, the service may rank the extracted attributes in a manner that is specific to the user associated with the input data.

In one or more embodiments, the algorithm used to rank the extracted attributes may include at least the following. The input to the algorithm may include natural language text. In some cases, the natural language text may include any of the search strings provided by the user for the given type of product. For example, a user searching for a laptop may input a text search string of “gaming laptop” when performing a search for a laptop. The natural language text may also include any other relevant types of text as well. The input may also include any other search information beyond text as well.

The output of the algorithm may include a mapping of each attribute to a specific ranking value based on a determined relevance of the attribute to the particular user. As an example, the extracted attributes for a particular user may include a color attribute, a product size attribute, and a brand attribute. Based on the algorithm, it may be determined that the color attribute is the most important attribute, the product size attribute is the second most important attribute, and the brand attribute is the least important attribute. That is, the user may be more interested in the color and the size of the product than the brand of the product. Based on this, the algorithm may assign rank values to the attributes in the following order: color, product size, and brand. The specific types of values that are associated with the attributes to indicate relative rankings may vary. For example, a numerical ranking value of “1” may indicate a most important ranking and may be provided to the color attribute and a numerical ranking value of “3” may indicate a less important ranking and may be provided to the brand attribute. However, the opposite may also be true (for example, the numerical ranking value of “3” may indicate a more important attribute ranking than a numerical ranking value of “1”). Additionally, the ranking value may not necessarily be limited to numerical values, but may be indicated in any other manner as well.

The algorithm may begin by identifying some or all possible values for some or all attributes of a product type from catalog data. For example, the “values” red, blue, green, etc. may include the possible range of values for the color attribute for a shoe product type. Once these values are determined, the following actions may be performed for each attribute. First, the algorithm may count the number of times an attribute value is present in the input text (which may be stored as variable “C1”). Second, the algorithm may count the number of times the attribute name or a variation of the attribute name is present in the input text corpus (which may be stored as variable “C2”). Third, the algorithm may establish a Count_Total variable as the sum of C1 and C2. Third, the attributes may be ranked based on the Count_Total value. For example, if Count_Total of the color attribute is greater than the Count_Total for any other attribute, then the color attribute may be provided the highest ranking.

In one or more embodiments, another algorithm (or the same algorithm) may also be used to score each attribute based on aggregated rankings. The algorithm may involve the use of various variables, including T_Q_Rank, T_Reviews_Rank, T_QNA_Rank, T_Return_Rank, T_Title_Rank, and/or T_Details_Rank.

T_Q_Rank may represent concatenated value of all search queries for the product type. The output value may include a map containing keys with all attributes of the product type and their associated rank as the mapped value. For example, a color attribute may be mapped to a rank value of 1, a size attribute may be mapped to a rank value of 2, and dimension attribute may be mapped to a rank value of 4.

T_Reviews_Rank may represent a concatenated value of all review comments of the product type. For example, if the color attribute is associated with two review comments, the color attribute value may be set to 2, the size attribute is associated with one review comment, the color attribute may be set to a value of 1, and the dimension attribute is associated with four review comments, the value of the dimension attribute may be set to 4.

T_QNA_Rank may represent a concatenated value of all questions and answers asked for products in the product type. For example, if a number of questions and answers associated with the color attribute is two, the color attribute value may be set to 2. If the number of questions and answers associated with the size attribute is one, then the value of the size attribute may be set to 1. If the number of questions and answers associated with the dimension attribute is four, then the value of the dimension attribute may be set to 4.

T_Return_Rank may represent a concatenated value of all return comments of products in the product type. For example, if a number of return comments associated with the color attribute is two, the color attribute value may be set to 2. If the number of return comments associated with the size attribute is one, then the value of the size attribute may be set to 1. If the number of return comments associated with the dimension attribute is four, then the value of the dimension attribute may be set to 4. T_Title_Rank may represent a concatenated value of all titles of products in the product type). T_Details_Rank may represent a concatenated value of all details of products in the product type).

Using the values associated with each of these variables as described above, the algorithm may calculate a SCORE_BASED_ON_RANK of for each attribute. This score may be calculated as follows: SCORE_PART_BASED_ON_RANK[attribute]=(1/T_Q_Rank[attribute])+(1/T_Reviews_Rank [attribute])+(1/T_QNA_Rank [attribute])+(1/T_Return_Rank [attribute])+(1/T_Title_Rank[attribute])+(1/T_Details_Rank[attribute]).

Operation 606 involves providing the input data received in operation 602 to an explore exploit based attribute ranking service. The explore exploit based attribute ranking service may continuously determine attribute rankings based on additional input data, such as additional user purchase data and/or any other types of data. In some cases, the exploit based attribute ranking service may involve a machine-learning algorithm used to solve a “multi-armed bandit problem.” However, the explore exploit based attribute ranking service may not necessarily be limited to a machine learning algorithm.

In one or more embodiments, the algorithm associated with the explore exploit based attribute ranking service may involve at least the following. For each attribute, a SCORE_EXPLOIT [attribute] variable may be set as the value of SCORE_PART_BASED_ON_RANK. Additionally, for each attribute, a SCORE_EXPLORE [attribute] variable may be set as the value of SCORE_PART_BASED_ON_RANK.

Once values for these variables are established, the algorithm may perform the following steps on a periodic basis (the example provided below recites the steps being performed on a daily basis, however this is not intended to be limiting). For each day, for a percentage (for example, 80% or any other percentage) of users, the top “K” attributes may be displayed based on the SCORE_EXPLOIT attribute. This threshold percentage of users may be presented dynamic product summary images based on the best known ranking.

For another percentage of the users (for example, 10% or any other percentage), the top “K” attributes may be displayed based on the SCORE_EXPLORE attribute. These users may be presented the next best ranking algorithm identified using econometric method mentioned below.

For another threshold percentage of the user (for example, 10% or any other percentage), an exploration may be performed by randomly assigning a RAND_EXPLORE[ ] value for each attribute and selecting top “K” attributes based on the random score. In short, top K attributes may randomly be selected.

At the end of the day (or any other time period), a regression analysis may be performed on the equation X_1*IS_SHOWN[attribute_1]+X_2*IS_SHOWN[attribute_2]+X_N*IS_SHOWN[attribute_N]=TOTAL Revenue generated for the ASIN for the day. This may be performed for some or all of the data collected in last 365 days (or as much as available). This may be regressed on an IS_SHOWN[ ] value, which may represent whether the attribute was shown to the user or not for each specific day. The regression analysis may return values for the unknown X_i's. The regression analysis may output values (X_1, X2, . . . , X_N) may be taken as the new SCORE_EXPLORE for each of the attributes for the next day.

If a total revenue generated by users who viewed the attributes in dynamic product summary image ranked based on SCORE_EXPLORE rank is higher than customers who had attributes ranked based on SCORE_EXPLOIT, then SCORE_EXPLOIT may be set to SCORE_EXPLORE. That is, this may be an explore exploit algorithm combined with an A/B test. SCORE_EXPLOIT may comprise the current best known scores which may be used for 80%. SCORE_EXPLOT may comprise a score based on regression analysis which is competing with SCORE_EXPLOIT in a continuous A/B setting. Whenever the regression-based scores are working better, the value may be set as SCORE_EXPLOT as better scores are determined and the process continues.

Operation 608 involves providing the rank attributed based on previous user product searches determined from operation 604 and the ranked attributes for the product type determined in operation 606 to a summary card image builder service. The summary card image builder service may use these inputs to build the final ranking algorithm, and then use the icon service to build the final dynamic product summary image to be presented to the user. For example, the service may use the ranking algorithm to decide the order and size of various attributes that may be presented as icons (as shown in at least FIGS. 1 and 3-5).

Operation 616 involves providing the dynamic product summary image produced in operation 614 to a retail web page generator service. In one or more embodiments, the retail web page generator service may be a server (for example, server 720, computing device 800, etc.) that provides the retail web page to a browser used by a user to access the web page. The server may use multiple micro services to build the final content of the page. This service may call and get the summary card image builder service to obtain the dynamic product summary image for the specific product page or for each product in the search results page. The retail web page generator service may provide the customer details, context of the page (detail page or search results), a list of products, and/or any other information to the summary card image builder service.

In one or more embodiments, an additional algorithm may be used to perform personalization of the dynamic product summary image. This algorithm may involve at least the following steps. First, the algorithm may collect a number of filters applied by the user while browsing to purchase a specific product type. Whenever the user searches for a product (for example, internal searches or from external search engines), the algorithm may extract the attribute values searched along with the product. For example red dress, maroon pants, XXL shirt, etc. Once such attribute values are collected the attribute values may be mapped to attribute names. For example, “red” and “maroon” may be mapped to the “color” attribute and “XXL” may be mapped to a “size” attribute.

The algorithm may also collect the number of times attribute filters are used by the customer. The algorithm may also count the number of times a customer has searched for each attribute (based on searches and web filters) and rank them based on the frequency. In some cases, importance of an attribute may be assumed to be linearly proportional to the number of times filters were used on the attribute. While building the summary card, if the top “K” personalized attributes are not part of the summary card, those attributes which are not already part of the top K rank may be determined and insert the personalized attribute alternatively. As one example, the value of K may be set to 3 (or any other value).

In addition to attribute extraction and ranking, the flow diagram 600 may also involve generating icons and/or obtaining existing icons to represent the attributes for presentation through the summary image. Operation 610 involves the use of a product-specific attributes visualization service. The product-specific attributes visualization service may create images specific to products. For example, the product-specific attributes visualization service may be used to generate images of the product that are at scale relative to a generic user image. For example, if the product is a trash bin, an image of a trash bin that is to scale relative to a human user may be generated. This image may be positioned next to a generic image of a human user within the summary image such that a size of the trash bin may be visualized. In one or more embodiments, generating the image at scale may be performed using an image of the product and dimensions information associated with the product. This may also be performed based on information obtained from selling partners, brands, product catalogs, etc. These images may then be stored in database 612, which may be a product-specific images database.

Operation 614 involves an icon service. The icon service 614 may receive product-specific images from the database 612. The icon service 614 may also receive previously-generated icons from database 618, which may be a stored icons database.

In one or more embodiments, the algorithm that is used to identify and/or generate icons may include at least the following. First, the most important attributes may be determined for all product types and attributes. This may be accomplished, for example, based on an average of SCORE_BASED_ON_RANK and SCORE_EXPLOIT. This first step may involve identifying regional rules for providing icons for these attributes. If no pre-existing icons exist for particular attributes, the algorithm may identify attributes which involve less than a threshold number of potential values. Icons for these different potential values of the attribute may then need to be generated.

Second, for each product type, the algorithm may identify the top K attributes (based on average of SCORE_BASED_ON_RANK and SCORE_EXPLOIT) which has less than five (or any other number) different possible values. The algorithm may then create icons for these values. The algorithm may also ensure no icons are duplicate of existing icons. Icons may also be provided by the selling partners and/or brands for each product.

### Illustrative System Architecture

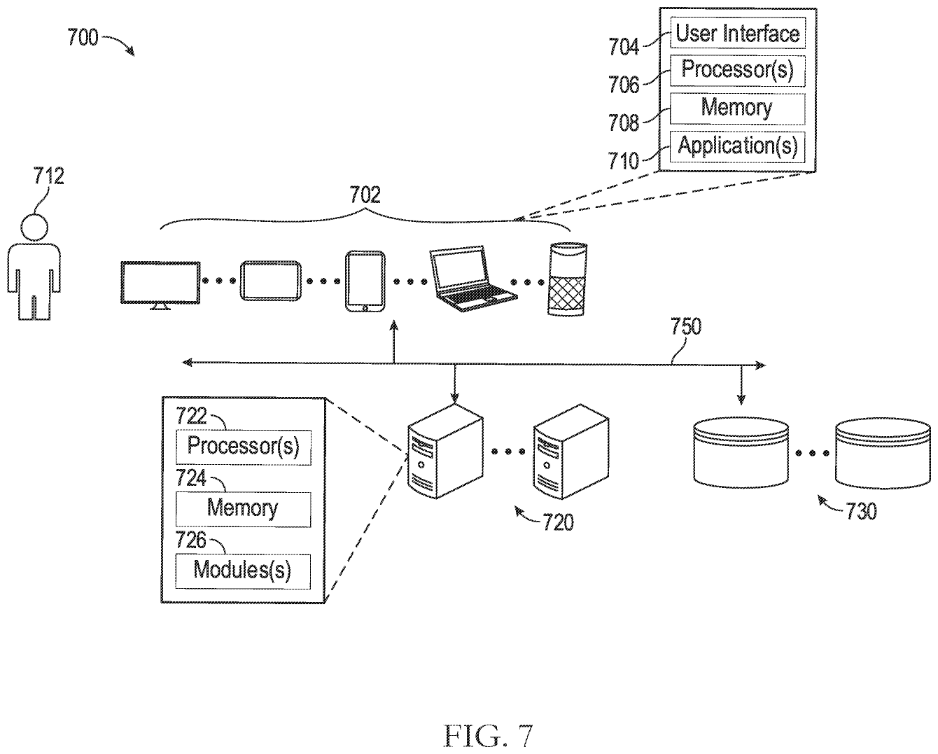

FIG. 7 is a schematic illustration of an example system 700 in accordance with one or more example embodiments of the disclosure. In one or more embodiments, the system 700 may include at least one or more user devices 702, one or more servers 720, and/or one or more databases 730. However, these components of the system 700 are merely exemplary and are not intended to be limiting in any way. For simplicity, reference may be made hereinafter to a “user device 702,” a “server 720,” and a “database 730,” however, this is not intended to be limiting and may still refer to any number of such elements.

The mobile device 702 may be any type of device that is used by a user 712 while browsing for products. For example, the user device 702 may include a desktop or laptop computer, tablet, smartphone, and/or any other type of device. The mobile device 702 may also include one or more processors 706 and memory 708. The mobile device 702 may also include an application 710 that may allow the user 712 to search for products, purchase products, post product review comments, and/or perform any other actions with respect to browsing for products. The products may be displayed to the user through a user interface 704 of the mobile device 702. Any dynamic product summary images that are generated in association with the application 710 may also be presented through the user interface 704.

The server 720 may be a local or remote system that is used to perform any of the processing described herein (for example, server 720 may host any of the algorithms described with respect to FIG. 3 and/or may perform any other processes described herein). The computing device 920 may also include one or more processors 722 and memory 724. Any of the processes may be facilitated by one or more module(s) 726.

The database 730 may include any storage medium that may be used to store any of the date described herein or otherwise (for example, database 612, database 618, and/or any other type of database described herein or otherwise). For example, the database 730 may store input data relating to user search queries, past search queries, product reviews, and/or any other input data. The database 730 may also store any of the icons that are used to produce the dynamic product summary image. The database 730 may also store pre-generated dynamic product summary images to recue the amount of processing time required to present dynamic product summary images that were previously presented.

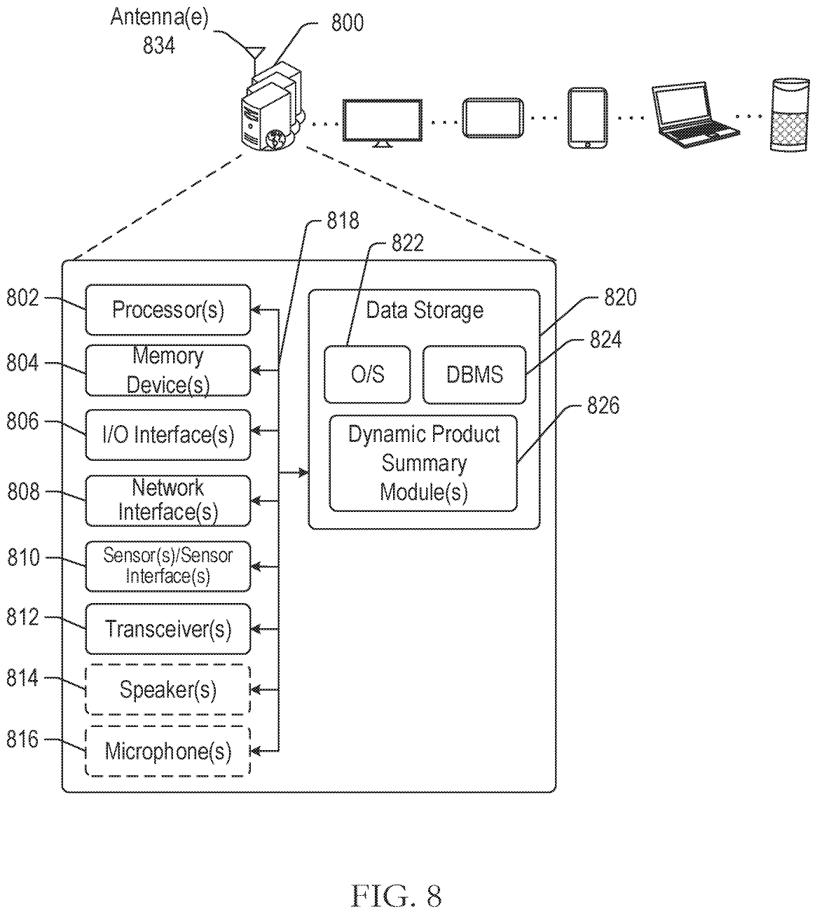

In one or more embodiments, any of the elements of the system 700 (for example, the user device 702, the server 720, the database 730, and/or any other element described with respect to FIG. 7 or otherwise) may be configured to communicate via a communications network 750. Examples of communication networks are further described with respect to FIG. 8. Finally, any of the elements of the system 700 may include any of the elements of the computing device 800 as well.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

### Illustrative Device Architecture

FIG. 8 is a schematic block diagram of an illustrative computing device 800 in accordance with one or more example embodiments of the disclosure. The computing device 800 may include any suitable computing device capable of receiving and/or generating data including, but not limited to, a mobile device such as a smartphone, tablet, e-reader, wearable device, or the like; a desktop computer; a laptop computer; a content streaming device; a set-top box; or the like. The computing device 800 may correspond to an illustrative device configuration for the devices of FIGS. 1-7.

The computing device 800 may be configured to communicate via one or more networks with one or more servers, search engines, user devices, or the like. In some embodiments, a single remote server or single group of remote servers may be configured to perform more than one type of content rating and/or machine learning functionality.

Example network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing device 800 may include one or more processors (processor(s)) 802, one or more memory devices 804 (generically referred to herein as memory 804), one or more input/output (I/O) interface(s) 806, one or more network interface(s) 808, one or more sensors or sensor interface(s) 810, one or more transceivers 812, one or more optional speakers 814, one or more optional microphones 816, and data storage 820. The computing device 800 may further include one or more buses 818 that functionally couple various components of the computing device 800. The computing device 800 may further include one or more antenna(e) 834 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 818 may include at least one of a system bus, a memory bus, an address bus, or a message bus, and may permit exchange of information (e.g., data (including computer-executable code), signaling, etc.) between various components of the computing device 800. The bus(es) 818 may include, without limitation, a memory bus or a memory controller, a peripheral bus, an accelerated graphics port, and so forth. The bus(es) 818 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 804 of the computing device 800 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 804 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 804 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 820 may include removable storage and/or non-removable storage including, but not limited to, magnetic storage, optical disk storage, and/or tape storage. The data storage 820 may provide non-volatile storage of computer-executable instructions and other data. The memory 804 and the data storage 820, removable and/or non-removable, are examples of computer-readable storage media (CRSM) as that term is used herein.

The data storage 820 may store computer-executable code, instructions, or the like that may be loadable into the memory 804 and executable by the processor(s) 802 to cause the processor(s) 802 to perform or initiate various operations. The data storage 820 may additionally store data that may be copied to memory 804 for use by the processor(s) 802 during the execution of the computer-executable instructions. Moreover, output data generated as a result of execution of the computer-executable instructions by the processor(s) 802 may be stored initially in memory 804, and may ultimately be copied to data storage 820 for non-volatile storage.

More specifically, the data storage 820 may store one or more operating systems (O/S) 822; one or more database management systems (DBMS) 824; and one or more program module(s), applications, engines, computer-executable code, scripts, or the like such as, for example, one or more dynamic product summary image module(s) 826. Some or all of these module(s) may be sub-module(s). Any of the components depicted as being stored in data storage 820 may include any combination of software, firmware, and/or hardware. The software and/or firmware may include computer-executable code, instructions, or the like that may be loaded into the memory 804 for execution by one or more of the processor(s) 802. Any of the components depicted as being stored in data storage 820 may support functionality described in reference to correspondingly named components earlier in this disclosure.

The data storage 820 may further store various types of data utilized by components of the computing device 800. Any data stored in the data storage 820 may be loaded into the memory 804 for use by the processor(s) 802 in executing computer-executable code. In addition, any data depicted as being stored in the data storage 820 may potentially be stored in one or more datastore(s) and may be accessed via the DBMS 824 and loaded in the memory 804 for use by the processor(s) 802 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like. In FIG. 8, the datastore(s) may include, for example, purchase history information, user action information, user profile information, a database linking search queries and user actions, and other information.

The processor(s) 802 may be configured to access the memory 804 and execute computer-executable instructions loaded therein. For example, the processor(s) 802 may be configured to execute computer-executable instructions of the various program module(s), applications, engines, or the like of the computing device 800 to cause or facilitate various operations to be performed in accordance with one or more embodiments of the disclosure. The processor(s) 802 may include any suitable processing unit capable of accepting data as input, processing the input data in accordance with stored computer-executable instructions, and generating output data. The processor(s) 802 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 802 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 802 may be capable of supporting any of a variety of instruction sets.

Referring now to functionality supported by the various program module(s) depicted in FIG. 8, the dynamic product summary image module(s) 826 may include computer-executable instructions, code, or the like that responsive to execution by one or more of the processor(s) 802 may perform functions including, but not limited to, performing any functionality associated with the dynamic product summary images as described herein, and the like (for example, receiving input data, identifying attributes, ranking attributes, generating icons, presenting the dynamic product summary image, and/or any other functionality).

Referring now to other illustrative components depicted as being stored in the data storage 820, the O/S 822 may be loaded from the data storage 820 into the memory 804 and may provide an interface between other application software executing on the computing device 800 and hardware resources of the computing device 800. More specifically, the O/S 822 may include a set of computer-executable instructions for managing hardware resources of the computing device 800 and for providing common services to other application programs (e.g., managing memory allocation among various application programs). In certain example embodiments, the O/S 822 may control execution of the other program module(s) to dynamically enhance characters for content rendering. The O/S 822 may include any operating system now known or which may be developed in the future including, but not limited to, any server operating system, any mainframe operating system, or any other proprietary or non-proprietary operating system.

The DBMS 824 may be loaded into the memory 804 and may support functionality for accessing, retrieving, storing, and/or manipulating data stored in the memory 804 and/or data stored in the data storage 820. The DBMS 824 may use any of a variety of database models (e.g., relational model, object model, etc.) and may support any of a variety of query languages. The DBMS 824 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computing device 800 is a mobile device, the DBMS 824 may be any suitable light-weight DBMS optimized for performance on a mobile device.

Referring now to other illustrative components of the computing device 800, the input/output (I/O) interface(s) 806 may facilitate the receipt of input information by the computing device 800 from one or more I/O devices as well as the output of information from the computing device 800 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computing device 800 or may be separate. The I/O devices may further include, for example, any number of peripheral devices such as data storage devices, printing devices, and so forth.

The I/O interface(s) 806 may also include an interface for an external peripheral device connection such as universal serial bus (USB), FireWire, Thunderbolt, Ethernet port or other connection protocol that may connect to one or more networks. The I/O interface(s) 806 may also include a connection to one or more of the antenna(e) 834 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, ZigBee network, etc.

The computing device 800 may further include one or more network interface(s) 808 via which the computing device 800 may communicate with any of a variety of other systems, platforms, networks, devices, and so forth. The network interface(s) 808 may enable communication, for example, with one or more wireless routers, one or more host servers, one or more web servers, and the like via one or more of networks.

The antenna(e) 834 may include any suitable type of antenna depending, for example, on the communications protocols used to transmit or receive signals via the antenna(e) 834. Non-limiting examples of suitable antennas may include directional antennas, non-directional antennas, dipole antennas, folded dipole antennas, patch antennas, multiple-input multiple-output (MIMO) antennas, or the like. The antenna(e) 834 may be communicatively coupled to one or more transceivers 812 or radio components to which or from which signals may be transmitted or received.

As previously described, the antenna(e) 834 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(e) 834 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(e) 834 may be configured to transmit or receive radio frequency signals within any suitable frequency range forming part of the unlicensed portion of the radio spectrum.

The antenna(e) 834 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 812 may include any suitable radio component(s) for—in cooperation with the antenna(e) 834—transmitting or receiving radio frequency (RF) signals in the bandwidth and/or channels corresponding to the communications protocols utilized by the computing device 800 to communicate with other devices. The transceiver(s) 812 may include hardware, software, and/or firmware for modulating, transmitting, or receiving—potentially in cooperation with any of antenna(e) 834—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 812 may further include hardware, firmware, or software for receiving GNSS signals. The transceiver(s) 812 may include any known receiver and baseband suitable for communicating via the communications protocols utilized by the computing device 800. The transceiver(s) 812 may further include a low noise amplifier (LNA), additional signal amplifiers, an analog-to-digital (A/D) converter, one or more buffers, a digital baseband, or the like.

The sensor(s)/sensor interface(s) 810 may include or may be capable of interfacing with any suitable type of sensing device such as, for example, inertial sensors, force sensors, thermal sensors, and so forth. Example types of inertial sensors may include accelerometers (e.g., MEMS-based accelerometers), gyroscopes, and so forth.

The optional speaker(s) 814 may be any device configured to generate audible sound. The optional microphone(s) 816 may be any device configured to receive analog sound input or voice data.

It should be appreciated that the program module(s), applications, computer-executable instructions, code, or the like depicted in FIG. 8 as being stored in the data storage 820 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the computing device 800, and/or hosted on other computing device(s) accessible via one or more networks, may be provided to support functionality provided by the program module(s), applications, or computer-executable code depicted in FIG. 8 and/or additional or alternate functionality. Further, functionality may be modularized differently such that processing described as being supported collectively by the collection of program module(s) depicted in FIG. 8 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 8 may be implemented, at least partially, in hardware and/or firmware across any number of devices.

It should further be appreciated that the computing device 800 may include alternate and/or additional hardware, software, or firmware components beyond those described or depicted without departing from the scope of the disclosure. More particularly, it should be appreciated that software, firmware, or hardware components depicted as forming part of the computing device 800 are merely illustrative and that some components may not be present or additional components may be provided in various embodiments. While various illustrative program module(s) have been depicted and described as software module(s) stored in data storage 820, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A method comprising:
receiving, using one or more processors, first input data including at least one of: a first search query for a first product from a first user, a prior search query of the first user, and a comment for the first product provided by the first user;
determining, using the one or more processors, and based on the first input data, a first attribute and a second attribute associated with the first product, wherein the first attribute comprises a first type of information describing the first product, and wherein the second attribute comprises a second type of information describing the first product;
determining, using the one or more processors, a first ranking score associated with the first attribute and a second ranking score associated with the second attribute;
determining, using the one or more processors, a first icon representative of the first attribute and a second icon representative of the second attribute, wherein the first icon provides a visual representation of the first attribute, and wherein the second icon provides a visual representation of the second attribute;
causing to present, using the one or more processors and via a user interface of a product page associated with the first product, a first dynamic product summary image including the first icon and the second icon, wherein an order of the first icon and the second icon within the first dynamic product summary image is based on the first ranking score and the second ranking score;
receiving, using the one or more processors, third input data indicative of a second search query for the first product from a second user, the second search query including a different search string than the first search query;
determining, using the one or more processors and based on the second search query, a third attribute and a fourth attribute associated with the first product;
determining, using the one or more processors, a third icon representative of the third attribute and a fourth icon representative of the fourth attribute; and
causing to present, using the one or more processors and via the user interface, a second dynamic product summary image instead of the first dynamic product summary image, the second dynamic product summary image including the third icon and the fourth icon.

2. The method of claim 1, wherein the first icon comprises an image of the first product, wherein a size of the image of the first product within the first icon is scaled based on a size of the first product.

3. The method of claim 2, wherein the first user is associated with a first geographical region or a first language, wherein the second user is associated with a second geographical region or a second language, wherein the first icon and second icon are based on the first geographical region or the first language, and wherein the third icon and fourth icon are based on the second geographical region or the second language.

4. The method of claim 1, further comprising:
receiving, using the one or more processors, fourth input data indicative of a third search query for the first product from the first user;
determining, using the one or more processors, and based on the fourth input data, a fifth attribute and a sixth attribute associated with the first product;
determining, using the one or more processors, a fifth icon representative of the fifth attribute and a sixth icon representative of the sixth attribute; and
causing to present, using the one or more processors and via the user interface, a dynamic product summary image including the fifth icon and the sixth icon.

5. A method comprising:
receiving, using one or more processors, first input data indicative of a first search query for a first product from a first user;
determining, using the one or more processors, and based on the first input data, a first attribute and a second attribute associated with the first product;
determining, using the one or more processors, a first icon representative of the first attribute and a second icon representative of the second attribute; and
causing to present, using the one or more processors and via a user interface of a product page associated with the first product, a first dynamic product summary image including the first icon and the second icon.

6. The method of claim 5, further comprising:
determining, using the one or more processors, a first ranking score associated with the first attribute and a second ranking score associated with the second attribute, wherein an order of the first icon and the second icon within the first dynamic product summary image is based on the first ranking score and the second ranking score.

7. The method of claim 5, further comprising:
receiving second input data comprising at least one of: a prior search query of the first user and a comment for the first product, wherein determining the first attribute and the second attribute is further based on the second input data, and wherein a number of icons included in the first dynamic product summary image is based on a size of a device on which the user interface is displayed.

8. The method of claim 5, further comprising:
receiving, using the one or more processors, third input data indicative of a second search query for the first product from a second user;
determining, using the one or more processors, a third attribute and a fourth attribute associated with the first product;
determining, using the one or more processors, a third icon representative of the third attribute and a fourth icon representative of the fourth attribute; and
causing to present, using the one or more processors and via the user interface, a dynamic product summary image including the third icon and the fourth icon.

9. The method of claim 8, wherein the first search query is received from a first user, and the second search query is received form a second user, wherein the first user being associated with a first geographical region or a first language, wherein the second user is associated with a second geographical region or a second language, wherein the first icon and second icon are based on the first geographical region or the first language, and wherein the third icon and fourth icon are based on the second geographical region or the second language.

10. The method of claim 5, further comprising:
receiving, using the one or more processors, fourth input data indicative of a third search query for the first product;
determining, using the one or more processors, and based on the fourth input data, a fifth attribute and a sixth attribute associated with the first product;
determining, using the one or more processors, a fifth icon representative of the fifth attribute and a sixth icon representative of the sixth attribute; and
causing to present, using the one or more processors and via the user interface, a dynamic product summary image including the fifth icon and the sixth icon.

11. The method of claim 5, wherein the first icon comprises an image of the first product, wherein a size of the image of the first product within the first icon is scaled based on a size of the first product.

12. The method of claim 5, wherein the user interface includes a search results page including a first product search result and a second product search result, wherein the first dynamic product summary image is caused to be presented with the first product search result, and wherein a second dynamic product summary image is caused to be presented with the second product search result.

13. A system comprising:
at least one memory that stores computer-executable instructions; and
one or more processors configured to access the memory and execute the computer-executable instructions to:
receive first input data indicative of a first search query for a first product from a first user;
determine, based on the first input data, a first attribute and a second attribute associated with the first product;
determine a first icon representative of the first attribute and a second icon representative of the second attribute; and
cause to present, via a user interface of a product page associated with the first product, a first dynamic product summary image including the first icon and the second icon.

14. The system of claim 13, wherein the computer-executable instructions further cause the one or more processors to:
determine a first ranking score associated with the first attribute and a second ranking score associated with the second attribute, wherein an order of the first icon and the second icon within the first dynamic product summary image is based on the first ranking score and the second ranking score.

15. The system of claim 13, wherein the computer-executable instructions further cause the one or more processors to:
receive second input data comprising at least one of: a prior search query of the first user and a comment for the first product provided by the first user, wherein determining the first attribute and the second attribute is further based on the second input data, and wherein a number of icons included in the first dynamic product summary image is based on a size of a device on which the user interface is displayed.

16. The system of claim 13, wherein the computer-executable instructions further cause the one or more processors to:
receive, using the one or more processors, third input data indicative of a second search query for the first product from a second user;
determine, using the one or more processors, a third attribute and a fourth attribute associated with the first product;
determine, using the one or more processors, a third icon representative of the third attribute and a fourth icon representative of the fourth attribute; and
cause to present, using the one or more processors and via the user interface, a dynamic product summary image including the third icon and the fourth icon.

17. The system of claim 16, wherein the first user is associated with a first geographical region or a first language, wherein the second user is associated with a second geographical region or a second language, wherein the first icon and second icon are based on the first geographical region or the first language, and wherein the third icon and fourth icon are based on the second geographical region or the second language.

18. The system of claim 13, wherein the computer-executable instructions further cause the one or more processors to:
receive, using the one or more processors, fourth input data indicative of a third search query for the first product;
determine, using the one or more processors, and based on the fourth input data, a fifth attribute and a sixth attribute associated with the first product;
determine, using the one or more processors, a fifth icon representative of the fifth attribute and a sixth icon representative of the sixth attribute; and
cause to present, using the one or more processors and via the user interface, a dynamic product summary image including the fifth icon and the sixth icon.

19. The system of claim 13, wherein the first icon comprises an image of the first product, wherein a size of the image of the first product within the first icon is scaled based on a size of the first product.

20. The system of claim 13, wherein the user interface includes a search results page including a first product search result and a second product search result, wherein the first dynamic product summary image is presented with the first product search result, and wherein a second dynamic product summary image is presented with the second product search result.
